(19) United States
(12) Patent Application Publication
(10) Pub. No.: US 2017/0171383 A1
(43) Pub. Date: Jun. 15, 2017

(54) APPARATUS AND METHOD FOR AUTOMATICALLY RECOVERING RINGTONE ALARM IN HANDHELD DEVICE

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventor: Xuebing YE, Beijing (CN)

(73) Assignees: LE HOLDINGS (BEIJING) CO., LTD., Beijing (CN); LEMOBILE INFORMATION TECHNOLOGY (BEIJING) CO., LTD ., Beijing (CN)

(21) Appl. No.: 15/243,120

(22) Filed: Aug. 22, 2016

Related U.S. Application Data
(63) Continuation of application No. PCT/CN2016/089518, filed on Jul. 10, 2016.

(30) Foreign Application Priority Data
Dec. 15, 2015 (CN) 2015109385339

(51) Int. Cl. H04M 3/42; H04M 1/725; H04W 68/00

(52) U.S. Cl. CPC H04M 3/42; H04W 68/005; H04M 1/72563

(57) ABSTRACT

An embodiment of the present disclosure relates to the technical field of automatically recovering ringtone alarm in a handheld device and discloses an apparatus and a method for automatically recovering ringtone alarm in a handheld device. The apparatus includes: a receiver, configured to receive a volume level setting instruction and a specified time; and a processor, configured to set, when the received volume level setting instruction indicates that a volume level is set to be lower than a preset volume level, the volume level to be an indicated volume level, and determine a duration of the indicated volume level according to the received specified time, and adjust the volume level to a volume level higher than the preset level after the duration reaches the specified time. With the technical solutions of this embodiment, a case where a user cannot hear alarm of an incoming call, an SMS message, or another message of the handheld device because of forgetting to turn up a volume level of the handheld device can be avoided.

### CROSS-REFERENCE TO RELATED APPLICATIONS

This application is a continuation of International Application No. PCT/CN 2016/089518, with an international filing date of Jul. 10, 2016, which is based upon and claims priority to Chinese Patent Application No. 201510938533.9, filed on Dec. 15, 2015, the entire contents of all of which are incorporated herein by reference.

### TECHNICAL FIELD

The present disclosure relates to technologies for automatically recovering ringtone alarm in a handheld device, and more particularly, to an apparatus and a method for automatically recovering ringtone alarm in a handheld device.

### BACKGROUND

In some application scenarios such as during a meeting, sleep, or a class, people usually need to turn down the volume of handheld devices. However, after the meeting, sleep, or class, people usually forget to turn up the volume of the handheld devices. In this case, if there is an incoming call, or an SMS message or another message is received, a user misses the call, or cannot view the SMS message, or the another message in time because of not hearing the call, the SMS message, or the another message, which brings great inconvenience to work and life. Even worse, missing an important call or not viewing an important SMS message in time will cause an extremely adverse consequence.

### SUMMARY

An objective of some embodiments of the present invention is to provide an apparatus and a method for automatically recovering ringtone alarm in a handheld device, so as to avoid that a user cannot hear alarm of an incoming call, an SMS message, or another message of the handheld device because of forgetting to recover ringtone alarm.

To achieve the above objective, an embodiment of the present disclosure provides an apparatus for automatically recovering ringtone alarm in a handheld device. The apparatus includes: a receiver, configured to receive a volume level setting instruction of the handheld device and a specified time; and a processor, configured to set, when the received volume level setting instruction indicates that a volume level of the handheld device is set to be lower than a preset volume level, the volume level of the handheld device to be a volume level indicated by the volume level setting instruction, determine, according to the received specified time, a duration for which the handheld device is in the indicated volume level, and adjust the volume level of the handheld device to a volume level higher than the preset level after the duration reaches the specified time.

Correspondingly, another embodiment of the present disclosure further provides a method for automatically recovering ringtone alarm in a handheld device. The method includes: receiving a volume level setting instruction of the handheld device and a specified time; and setting, when the received volume level setting instruction indicates that a volume level of the handheld device is set to be lower than a preset volume level, the volume level of the handheld device to be a volume level indicated by the volume level setting instruction, determining, according to the received specified time, a duration for which the handheld device is in the indicated volume level, and adjusting the volume level of the handheld device to a volume level higher than the preset level after the duration reaches the specified time.

According to an embodiment of the present disclosure, there is provided with a non-transitory computer-readable storage medium storing executable instructions that, when executed by an electronic apparatus, cause the electronic apparatus to perform an above disclosed method.

With the foregoing technical solutions, according to some embodiments of the present disclosure, when a volume level of a handheld device is set to be lower than a preset volume level, a volume level of the handheld device is turned up according to a specified time, thereby avoiding a case where a user cannot hear alarm of an incoming call, an SMS message, or another message of the handheld device because of forgetting to turn up a volume level of the handheld device.

Other features and advantages of the present disclosure are described in detail in the detailed description hereinafter.

### BRIEF DESCRIPTION OF THE DRAWINGS

The accompanying drawings are used to provide a further understanding of some embodiments of the present disclosure, and constitute a part of this specification, which are used to explain the present disclosure in combination with the following specific implementation manners, but do not constitute a limitation to the present disclosure. In the accompanying drawings:

FIG. 1 is a block diagram illustrating an apparatus for automatically recovering ringtone alarm in a handheld device according to an embodiment of the present disclosure;

FIG. 2 is a flowchart illustrating setting for automatically recovering ringtone alarm according to an embodiment of the present disclosure; and

FIG. 3 is a flowchart illustrating a method for automatically recovering ringtone alarm in a handheld device according to an embodiment of the present disclosure.

FIG. 4 is a schematic hardware diagram of an electronic apparatus for performing a method of automatically recovering ringtone alarm according to an embodiment of the present disclosure.

### DETAILED DESCRIPTION

Specific implementation manners of some embodiments of the present disclosure are described in detail with reference to accompanying drawings hereinafter. It should be understood that the specific implementation manners described herein are merely used to describe and explain the present disclosure, but not intended to limit the present disclosure.

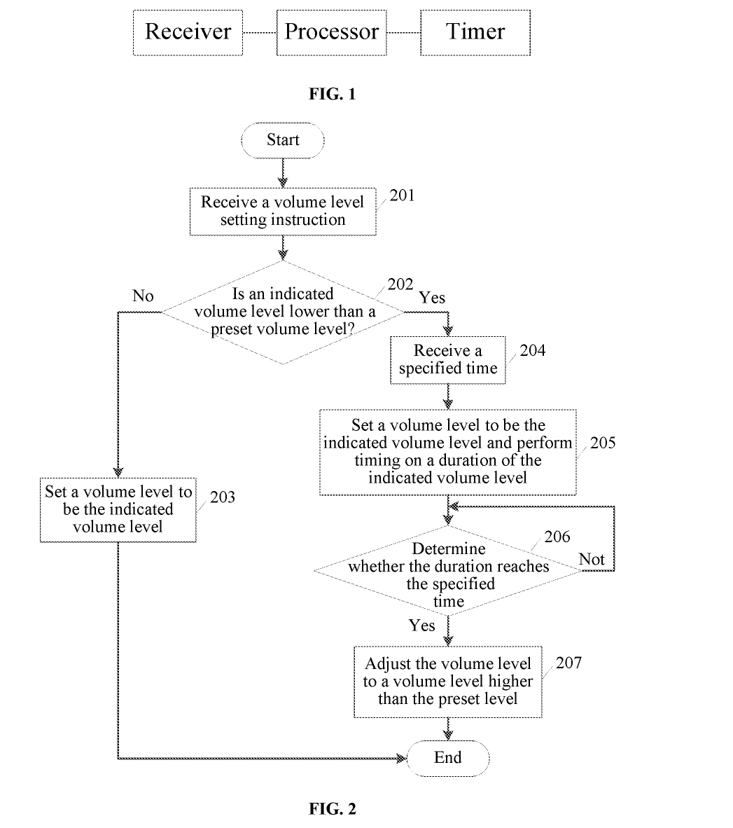

FIG. 1 is a block diagram illustrating an apparatus for automatically recovering ringtone alarm in a handheld device according to an embodiment of the present disclosure. As illustrated in FIG. 1, the apparatus includes a receiver and a processor. The receiver is configured to receive a volume level setting instruction of the handheld device and a specified time. The processor is configured to set, when the received volume level setting instruction indicates that a volume level of the handheld device is set to be lower than a preset volume level, the volume level of the handheld device to be a volume level indicated by the volume level setting instruction, determine, according to the received specified time, a duration for which the handheld device is in the indicated volume level, and adjust the volume level of the handheld device to a volume level higher than the preset level after the duration reaches the specified time.

When having a meeting, a class, or a sleep, people usually turn down the volume of a handheld device; however, after the meeting, class, or sleep, people may forget to turn up the volume of the handheld device, which brings inconvenience to work and life. Therefore, when receiving the volume level setting instruction of the handheld device, the receiver also receives the specified time. When the specified time expires after the volume of the handheld device is turned down, the processor automatically turns up the volume level of the handheld device, thereby avoiding, without an autonomous operation of a user, a case where the user forgets to adjust the volume.

The preset volume level herein generally refers to a volume level of a relatively low level. Assuming that the volume level of the handheld device ranges from 0 to 15 (totally 16 levels), the preset volume level may be 2 or 3. Nevertheless, the preset volume level may be another volume level. When the volume level of the handheld device is lower than the preset volume level and lasts for the specified time, the processor adjusts the volume level of the handheld device to a volume level higher than the preset level. The volume level higher than the preset level herein may be a volume level that is preset. Another implementation manner is to recover the volume level of the handheld device to a volume level of the handheld device before the volume level of the handheld device is set according to the volume level setting instruction.

For example, assuming that the preset volume level is 2, the volume level of the handheld device is 7 before the receiver receives the volume level setting instruction of the handheld device, and a volume level indicated by the volume level setting instruction received by the receiver is 1 (that is, the volume level is lower than the preset volume level), the processor sets the volume level of the handheld device to 1. In addition, the receiver also receives a specified time (for example, 30 minutes, one hour, or two hours). Assuming that the specified time is two hours, the processor adjusts the volume level of the handheld device to 7 when a duration for which the volume level of the handheld device is 1 reaches two hours. The specified time herein may also be a time autonomously set by the user, for example, 25 minutes.

It is easily understood that, a user generally switches a handheld device to a mute mode during a meeting, a sleep, or a class. The mute mode herein is a state in which the volume level is 0. Therefore, the volume level indicated by the volume level setting instruction in the above description may be a mute mode, and correspondingly, the volume level higher than the preset level may be a non-mute mode.

As illustrated in FIG. 1, the apparatus for automatically recovering ringtone alarm in a handheld device according to an embodiment of the present invention may further include a timer. The timer is configured to perform timing on the duration, so that the processor can determine whether the duration reaches the specified time according to a timing time of the timer.

The handheld device described in this embodiment may be a mobile phone. Certainly, this embodiment is not limited thereto. All handheld devices that can receive an SMS message or other information or a call such as a notebook computer and a tablet computer fall within the protection scope of the present invention.

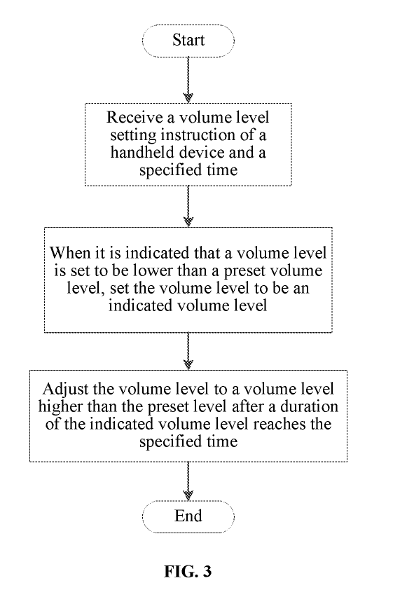

The following further describes another embodiment of the present disclosure with reference to FIG. 2. FIG. 2 is a flowchart illustrating setting for automatically recovering ringtone alarm according to a specific implementation manner of an embodiment of the present disclosure. In FIG. 2, the handheld device is a mobile phone. As illustrated in FIG. 2, the setting includes the following steps:

Step 201: Receive a volume level setting instruction. The operation in this step is set by a user by using a volume button or a setting function of the mobile phone. If the user hopes to switch the mobile phone to a mute mode, the mute mode may be set by using a mute button.

Step 202: Determine whether a volume level indicated by the volume level setting instruction is lower than a preset volume level; if it is determined that the volume level is lower than the preset volume level, indicating that the user only hopes to turn down the volume of the mobile phone, perform step 203; or otherwise, perform step 204.

Step 203: Set a volume level of the mobile phone to be the indicated volume level.

Step 204: Receive a specified time. When it is determined that the volume level indicated by the volume level setting instruction is lower than the preset volume level, a dialog box, in which the user is required to select a specified time, pops up on a screen of the mobile phone. For example, the dialog box may provide the following options: 30 minutes, one hour, two hours, and user-defined. It can be understood by a person skilled in the art that, the dialog box herein may be in combination with the prior art, that is, an option of “manual adjustment” is added to the options. When the user selects the option “manual adjustment,” the processor does not automatically adjust the volume level of the mobile phone, and the volume level needs to be adjusted by the user.

Step 205: Set a volume level to be the indicated volume level and perform timing on a duration for which the mobile phone is in the indicated volume level, that is, it is required to perform timing on a duration for which the mobile phone is in the lowered volume level. For example, if the user switches the mobile phone to a mute mode, timing is performed on a duration for which the mobile phone is in the mute mode.

Step 206: Determine whether the duration reaches the specified time; if it is determined that the duration does not the specified time, skip performing any operation; or otherwise, perform step 207.

Step 207: Adjust the volume level to a volume level higher than the preset level, for example, adjust to a volume level before the volume level setting instruction is received.

FIG. 3 is a flowchart illustrating a method for automatically recovering ringtone alarm in a handheld device according to an embodiment of the present disclosure. As illustrated in FIG. 3, the method includes: receiving a volume level setting instruction of the handheld device and a specified time; and setting, when the received volume level setting instruction indicates that a volume level of the handheld device is set to be lower than a preset volume level, the volume level of the handheld device to be a volume level indicated by the volume level setting instruction, determining, according to the received specified time, a duration for which the handheld device is in the indicated volume level, and adjusting the volume level of the handheld device to a volume level higher than the preset level after the duration reaches the specified time.

It should be noted that, specific details and benefits of the method for automatically recovering ringtone alarm in a handheld device provided in this embodiment are similar to those of the apparatus for automatically recovering ringtone alarm in a handheld device provided in an embodiment of the present disclosure, and details are not described herein again.

Preferable implementation manners of some embodiments of the present disclosure are described above in detail with reference to the accompanying drawings. However, the present disclosure is not limited to specific details in the foregoing implementation manners. Multiple simple variations can be made to the technical solutions of the present disclosure within the technical idea scope of the present disclosure, and these simple variations all fall within the protection scope of the present disclosure.

With the technical solutions according to some embodiments of the present disclosure, when the handheld device is a mobile phone, if a user switches the mobile phone to a mute mode, the mobile phone automatically recovers from the mute mode to a non-mute mode after a set specified time, so as to avoid missing a call or not viewing an SMS message in time in the mute mode. Some embodiments of the present invention can be implemented by modifying a ring volume from a Framework layer to a bottom layer of a system.

According to an embodiment of the present disclosure, there is provided with a non-transitory computer-readable storage medium storing executable instructions that, when executed by an electronic apparatus, cause the electronic apparatus to perform any one of above disclosed methods.

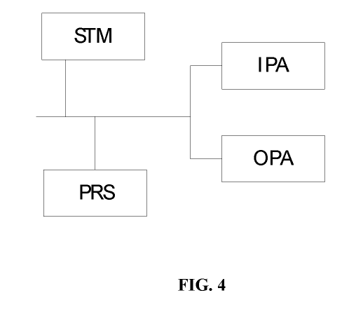

FIG. 4 illustrates a schematic hardware diagram of an electronic apparatus for performing any one of above disclosed methods. According to FIG. 4, the electronic apparatus includes one or more processors PRS and a storage medium STM. FIG. 4 shows one processor PRS as an example.

The electronic apparatus can further include an input apparatus IPA and an output apparatus OPA.

The one or more processors PRS, storage medium STM and output apparatus OPA may be connected by a bus or other means. FIG. 4 shows a bus as an example for connection.

Storage medium STM is a non-transitory computer-readable medium for storing a non-transitory software program, a non-transitory computer-readable program and module, for example the program instructions/module for performing an above described method (e.g. processor and timer shown in FIG. 1). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player(e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.

(5) Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e.in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

In addition, it should be noted that, each specific technical feature described in the foregoing specific implementation manners may be combined in a proper manner under the premise of not colliding with each other. To avoid unnecessary redundancies, the present disclosure does not describe various possible combination manners.

In addition, various different implementation manners of the present disclosure may also be randomly combined. The combinations may also considered as disclosed content of the present invention as long as the combinations do not depart from the concept of the present disclosure.

1. An apparatus for automatically recovering ringtone alarm in a handheld device, comprising:
a receiver, configured to receive a volume level setting instruction of the handheld device and a specified time; and
a processor, configured to:
set, when the received volume level setting instruction indicates that a volume level of the handheld device is set to be lower than a preset volume level, the volume level of the handheld device to be a volume level indicated by the volume level setting instruction;
determine, according to the received specified time, a duration for which the handheld device is in the indicated volume level; and
adjust the volume level of the handheld device to a volume level higher than the preset level after the duration reaches the specified time.

2. The apparatus according to claim 1, wherein the volume level indicated by the volume level setting instruction is a mute mode, and the volume level higher than the preset level is a non-mute mode.

3. The apparatus according to claim 1, wherein the adjusting the volume level of the handheld device to a volume level higher than the preset level comprises:
recovering the volume level of the handheld device to a volume level of the handheld device before the volume level of the handheld device is set according to the volume level setting instruction.

4. The apparatus according to claim 1, wherein the apparatus further comprises:
a timer, configured to perform timing on the duration, wherein the processor determines whether the duration reaches the specified time according to a timing time of the timer.

5. The apparatus according to claim 1, wherein the handheld device is a mobile phone.

6. A method for automatically recovering ringtone alarm in a handheld device, comprising:
receiving a volume level setting instruction of the handheld device and a specified time; and
setting, when the received volume level setting instruction indicates that a volume level of the handheld device is set to be lower than a preset volume level, the volume level of the handheld device to be a volume level indicated by the volume level setting instruction, determining, according to the received specified time, a duration for which the handheld device is in the indicated volume level, and adjusting the volume level of the handheld device to a volume level higher than the preset level after the duration reaches the specified time.

7. The method according to claim 6, wherein the volume level indicated by the volume level setting instruction is a mute mode, and the volume level higher than the preset level is a non-mute mode.

8. The method according to claim 6, wherein the adjusting the volume level of the handheld device to a volume level higher than the preset level comprises:
recovering the volume level of the handheld device to a volume level of the handheld device before the volume level of the handheld device is set according to the volume level setting instruction.

9. The method according to claim 6, further comprising:
performing timing on the duration; and
determining whether the duration reaches the specified time according to a timing time.

10. A non-transitory computer-readable storage medium storing executable instructions that, when executed by an electronic apparatus, cause the electronic apparatus to:
after receiving a volume level setting instruction and a specified time by the electronic apparatus, set, when the received volume level setting instruction indicates that a volume level of the electronic apparatus is set to be lower than a preset volume level, the volume level of the electronic apparatus to be a volume level indicated by the volume level setting instruction;
determine, according to the received specified time, a duration for which the handheld device is in the indicated volume level; and, adjust the volume level of the handheld device to a volume level higher than the preset level after the duration reaches the specified time.

11. The storage medium according to claim 10, wherein the volume level indicated by the volume level setting instruction is a mute mode, and the volume level higher than the preset level is a non-mute mode.

12. The storage medium according to claim 10, wherein to cause the electronic apparatus to adjust the volume level of the handheld device to a volume level higher than the preset level, the storage medium comprises further instructions to:
recover the volume level of the handheld device to a volume level of the handheld device before the volume level of the handheld device is set according to the volume level setting instruction.

13. The storage medium according to claim 10, wherein the storage medium further comprises instructions to:
perform timing on the duration; and
determine whether the duration reaches the specified time according to a timing time.
